(19) United States
(12) Patent Application Publication
(10) Pub. No.: US 2003/0025979 A1
(43) Pub. Date: Feb. 6, 2003

(54) Surface distortion compensated photolithography

(75) Inventors: Kin Foong Chan, Plano, TX (US); Wenhui Mei, Plano, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX

(21) Appl. No.: 10/035,387

(22) Filed: Dec. 28, 2001

Related U.S. Application Data
(63) Continuation-in-part of application No. 09/918,732, filed on Jul. 31, 2001.

(51) Int. Cl. G02F 1/03; G02F 1/07; G02F 1/01

(52) U.S. Cl. 359/279

(57) ABSTRACT

A distortion compensation system for use in an imaging device such as a photolithography system is described. The system projects a plurality of image portions onto a plurality of portions of a subject. The system includes a plurality of light-distance modulators corresponding to the plurality of image portions and a mechanical manipulator for individually manipulating each of the light-distance modulators. In this way, any distortion in the subject is compensated by the individual manipulation of the light-distance modulators.

### BACKGROUND

The present application is a continuation-in-part of U.S. patent application Ser. No. 09/918,732 filed Jul. 31, 2001, which is hereby incorporated by reference.

The present invention relates generally to optical systems, and more particularly, to optical display systems such as photolithography systems.

It is often a goal of optical display systems to project an image onto a subject that is properly focused across the entire surface of the subject. Such a goal becomes difficult to achieve when the subject's surface is not flat. For example, a printed circuit board may be relatively flat, but have some variable distortions in its surface. In another example, a curved film may not have any variable distortions, but because it is not flat, it is still difficult to focus an image over the entire surface. In a third example, a semiconductor may be spherical in shape and may also have some variable distortions, both of which make it difficult to focus an image over the entire surface of the subject. What is desired is an advance in optical display systems to accommodate surface distortion of various kinds.

### SUMMARY

A technical advance is achieved by a distortion compensation system for use in an imaging device such as a photolithography system. In one embodiment, the system projects a plurality of image portions onto a corresponding plurality of surface portions of a subject. The system includes a plurality of light-distance modulators corresponding to the plurality of image portions and a mechanical manipulator for individually manipulating each of the light-distance modulators. In this way, any distortion in the subject is compensated by the individual manipulation of the light-distance modulators.

In another embodiment, an optical system is provided for use with an image source for projecting an image onto a surface having a surface plane. The optical system includes a first optical device corresponding to the surface plane and spaced from the surface plane at a predetermined distance. The first optical device includes a plurality of individual distance modulators each for receiving a portion of the image and reflecting the portion to a portion of the surface. Each modulator individually adjusts to modify the distance between it and the surface plane. The optical system also includes a second optical device for receiving the image and directing the image towards the first optical device.

In another embodiment, a system is provided for projecting an image onto a surface, the surface having first and second portions that are not planar with each other. The system includes a light source for projecting a light onto a mask having first and second mask portions for converting the light to first and second images, respectively. The system also includes first and second lens subsystems corresponding to the first and second images and the first and second surface portions, respectively. The system further includes first and second support structures for individually positioning the first and second lens subsystems and mask portions, respectively, so that a depth of focus for the first and second images can be individually adjusted for the corresponding surface portion.

In another embodiment, a digital photolithography system is provided for projecting an image onto a surface having first and second portions. The system includes a light source for projecting a light and first and second digital pixel panels for converting the light into first and second images, respectively. The system also includes first and second lens subsystems corresponding to the first and second images and the first and second surface portions, respectively. The system further includes a micro-manipulator for individually positioning the first lens subsystem so that a depth of focus for the first image can be individually adjusted for the first surface portion.

### BRIEF DESCRIPTION OF THE DRAWINGS

FIGS. 1a-1b are simplified block diagrams of photolithography systems that will benefit from various embodiments of the present invention.

FIGS. 2-4 and 7 are diagrammatic view of a distortion compensation system for use in either of the systems of FIGS. 1a or 1b.

FIGS. 5-6 are operational views of a portion of the distortion compensation system shown in FIG. 4.

### DETAILED DESCRIPTION

The present disclosure relates to optical devices and optical systems, such as can be used in photolithographic processing. It is understood, however, that the following disclosure provides many different embodiments, or examples, for implementing different features of the invention. Specific examples of components and arrangements are described below to simplify the present disclosure. These are, of course, merely examples and are not intended to limit the invention from that described in the claims. In addition, the present disclosure may repeat reference numerals and/or letters in the various examples. This repetition is for the purpose of simplicity and clarity and does not in itself dictate a relationship between the various embodiments and/or configurations discussed.

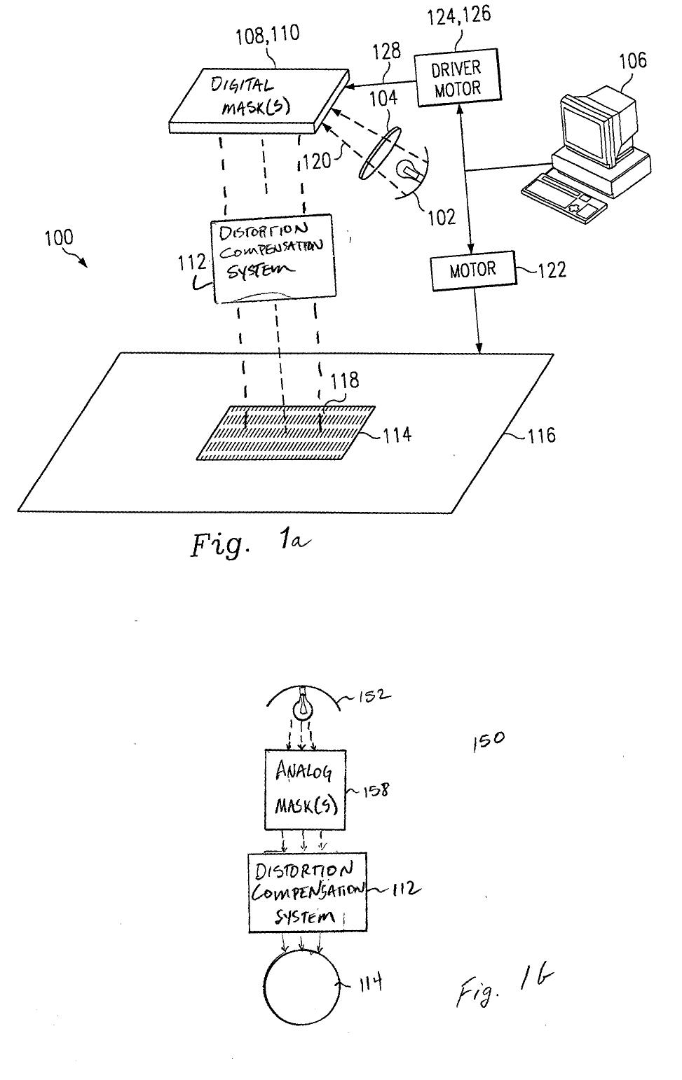

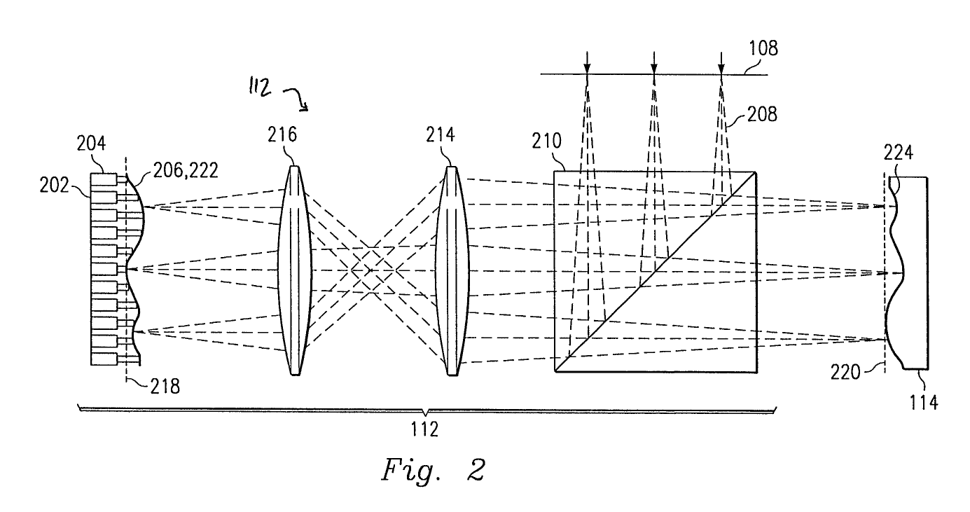

Referring now to FIG. 1a, a digital photolithography system 100 is one example of a system that can benefit from the present invention. In the present example, the digital photolithography system 100 includes a light source 102, a first lens system 104, a computer aided pattern design system 106, one or more digital masks 108, a panel alignment stage 110, a distortion compensation system 112, a subject 114, and a subject stage 116. A resist layer or coating 118 may be disposed on the subject 114. The light source 102 may be an incoherent light source (e.g., a Mercury lamp) that provides a collimated beam of light 120 which is projected through the first lens system 104 and onto the pixel panel 108. The light 120 is of a type (e.g., wavelength and intensity) that can expose the resist layer 118, as is well known in the art.

In one embodiment, the digital masks 108 include one or more pixel panels, such as a digital/deformable mirror device (“DMD”) or liquid crystal display (“LCD”). The pixel panels are provided with digital data via suitable signal line(s) 128 from the computer aided pattern design system 106 to create a desired pixel pattern (the pixel-mask pattern). The pixel-mask pattern may be available and resident at each pixel panel 108 for a desired, specific duration. Light emanating from (or through) the pixel-mask pattern of the pixel panel 108 then passes through the distortion compensation system 112 (discussed in greater detail below) and onto the subject 114. In this manner, the pixel-mask pattern is projected onto the resist coating 118 of the subject 114.

The computer aided mask design system 106 can be used for the creation of the digital data for the pixel-mask pattern. The computer aided pattern design system 106 may include computer aided design (CAD) software similar to that which is currently used for the creation of mask data for use in the manufacture of a conventional printed mask. Any modifications and/or changes required in the pixel-mask pattern can be made using the computer aided pattern design system 106. Therefore, any given pixel-mask pattern can be changed, as needed, almost instantly with the use of an appropriate instruction from the computer aided pattern design system 106. The computer aided mask design system 106 can also be used for adjusting a scale of the image or for correcting image distortion.

In some embodiments, the computer aided mask design system 106 is connected to a first motor 122 for moving the stage 116, and a driver 124 for providing digital data to the pixel panels 108. In some embodiments, an additional motor 126 may be included for moving the pixel panel. The system 106 can thereby control the data provided to the pixel panel 108 in conjunction with the relative movement between the pixel panels 108 and the subject 114.

Referring now to FIG. 1b, an analog photolithography system 150 is another example of a system that can benefit from the present invention. In the present example, the analog photolithography system 150 includes a light source 152, one or more analog masks 158, a mask alignment stage 160, the distortion compensation system 112, and the subject 114. The analog system 150 may include many of the same components as the digital system 100 (FIG. 1a), which have been omitted from FIG. 1b for the sake of clarity.

To illustrate the diversity of the present invention, the subject 114 of FIG. 1b is illustrated as a sphere while the subject 114 of FIG. 1a is illustrated as a relatively flat printed circuit board. It is understood, however, that the present invention applies to any shaped subject. For the following discussion, many different shaped subjects will be used interchangeable for the sake of example.

Referring now to FIG. 2, using the digital photolithography system of FIG. 1a as an example, one embodiment of the distortion compensation system 112 includes a phase shift device 202 to adjust the projection of light onto the subject 114. The phase shift device 202, one embodiment of which is discussed in greater detail in presently incorporated U.S. patent application Ser. No. 09/918,732, is operable to project light in such a way as to account for surface irregularities on the subject 114. In the present embodiment, the phase shift device 202 includes a plurality of actuators 204 which control the displacement of a surface 206. The surface 206 is reflective and so operable as a mirror.

In operation, light 208 is reflected from one of the masks 108 and into a beam splitter 210. The beam splitter 210 is operable to reflect a portion of the light and allow a portion of the light to pass through. The portion of the light reflected by the beam splitter 204 enters a lens 214. The light passes from the lens 214 into a lens 216, which projects the light onto the phase shift device 202.

The mirror 206 of the phase shift device 202 may initially be at a neutral position, which is defined for purposes of illustration to correspond to an image plane 218. The light is reflected from the mirror 206 through the lenses 216, 214 and into the beam splitter 210. The beam splitter 210 passes a portion of the light through in the direction of the subject 114. The light which passes through the beam splitter 210 is focused on an image plane 220 as follows.

The lenses 214, 216 will ordinarily focus an image located at the image plane 218 onto the image plane 220, assuming the lenses remain in a constant location. Moving the image plane 218 closer to the lenses will move the location of the image plane 220 away from the lenses. Moving the image plane 218 away from the lenses will move the location of the image plane 220 closer to the lenses. Therefore, the distance of the image plane 218 from the lenses determines the distance of the image plane 220 from the lenses.

If the focal length of the distortion compensation system formed by lenses 214, 216 remains constant, then displacing a portion of the image plane 218 will move the corresponding portion of the image plane 220 the same distance. Likewise, by displacing multiple portions of the image plane 218 by different amounts, each corresponding portion of the image plane 220 will be similarly displaced. Therefore, by controlling portions of the image plane 218, the location of various portions of the image plane 220 can be controlled.

The actuators 204 of the phase shift device 202 are operable to displace the mirror 206 so as to displace the original image plane 218 to a displaced image plane 222. By controlling the displacement of the mirror 206, the phase of portions of the light may be altered in a controllable manner. The light, after being reflected by the displaced mirror 206 of the phase shift device 202, is focused on a displaced image plane 224 instead of the original image plane 220. The displaced image plane 224 is similar to the image plane 222 formed by the mirror 206. The amount of similarity may depend on the resolution of the distortion compensation system, the properties of the beam splitter, and similar issues. In this manner, the image projected by the mask 108 maybe distorted in a controllable manner and projected onto the subject 114.

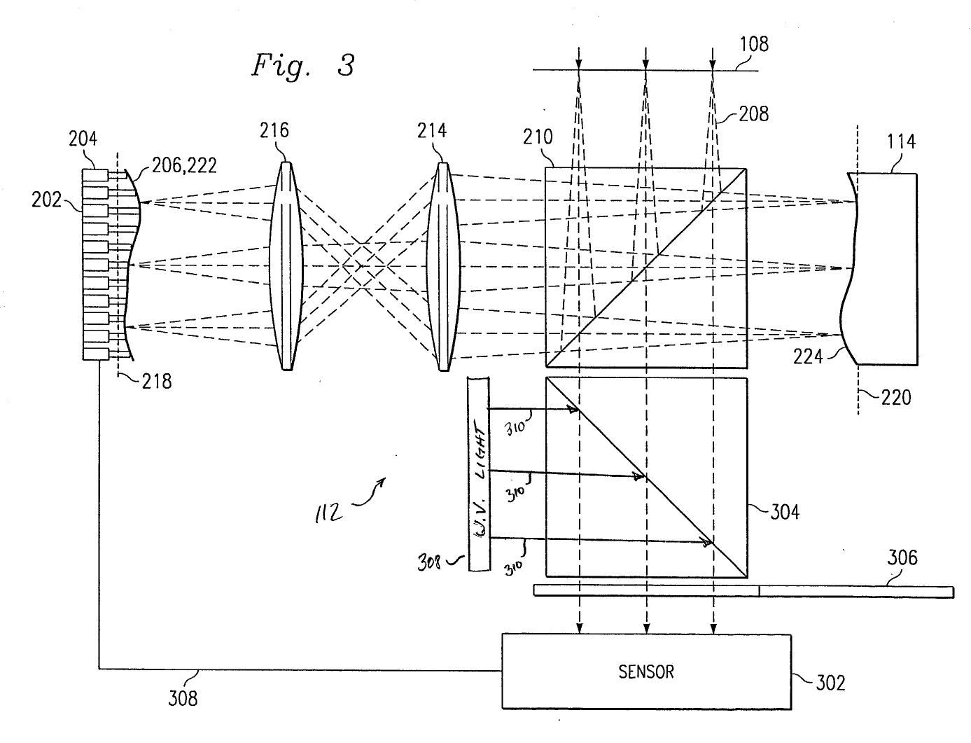

Referring now to FIG. 3, another embodiment of the distortion compensation system 112 is illustrated with the addition of a sensor 302, which in the present embodiment is a Shack-Hartmann wavefront sensor, to correct for surface irregularities in the subject 114. The sensor 302 may detect irregularities in the nanometer range on the surface of the subject 114 by receiving a wavefront which embodies the surface of the subject 114. The wavefront may then be analyzed to determine information such as the location and magnitude of irregularities. The resulting wavefront analysis information may be used to adjust the displacement of the mirror 206 of the phase shift device 202 so as to account for the irregularities.

In operation, as in FIG. 2, light 208 travels from the mask 108 into the beam splitter 210. A portion of the light 208 is reflected by the beam splitter 204 into the lens 214. Another portion of the light 208 passes through the beam splitter 204. The light passes from the lens 214 into the lens 216, which projects the light onto the phase shift device 202.

As in FIG. 2, the mirror 206 of the phase shift device 202 may ordinarily be at a neutral position, which is defined for purposes of illustration to correspond to an image plane 218. The light is reflected from the mirror 206 through the lenses 216, 214 and into the beam splitter 210. The beam splitter 210 passes a portion of the light through in the direction of the subject 114. If the mirror 206 is in the neutral position (forming the image plane 118), the light will be focused on a similar image plane 220 on the subject 114. If irregularities exist on the surface of the subject 114, the light will not be properly focused at those points. Assuming that the surface of the subject does not conform to the image plane 220, the light which is reflected by the subject 114 will be reflected from an image plane 224 which is formed by the surface of the subject 114. The light will be reflected back into the beamsplitter 210, which in turn reflects a portion of the light into a second beamsplitter 304. A portion of the light passes through the beamsplitter 304 and into a filter 306, such as a rotating filter. Light exiting from the rotating filter 306 enters the sensor 302.

The sensor 302 is operable to detect the light reflected from the surface of the subject 114 as wavefront information, which is passed to a computer system (e.g., computer 106 of FIG. 1). The computer system 106 may analyze the information to identify irregularities, calculate the magnitude and/or location of the irregularities, and perform similar operations. In addition, the computer system may be connected to the phase shift device 202 by one or more signal lines 308. The computer system 106 utilizes the information obtained about surface irregularities of the subject 114 to send signals to the phase shift device 202. The signals serve to control the actuators 204 and the displacement of the mirror 206 (and, therefore, form a new image plane 222) in such a way as to make corrections for the irregularities on the surface of the subject 114.

Following this displacement of the mirror 206, the light projected from the mask 108, off the beam splitter 210, and through the lenses 214, 216 will reflect from the image plane 222 formed by the displaced mirror 206, rather than the original image plane 218. The light will be reflected through the lenses 216, 214 and the beam splitter 210. The reflected light, which includes phase shifted light caused by the displacement of the mirror 206, will be properly focused onto the image plane 224 formed by the surface of the subject 114.

Therefore, the mirror 206 is deformed by the actuators 204 in such a manner as to “mirror” the deformations on the surface of the subject 114 and thus cause the light projected onto the surface to be uniformly in focus. Further refinements of the image plane 224 may occur by repeating the operation through the sensor 302 and correcting the image plane 222 formed by the mirror 206. It is noted that the distortion compensation system may act as a multiplier for the measured substrate surface irregularities, thus allowing very small changes of position of the mirror 206 to be optically magnified to adjust for larger subject surface defects.

In another embodiment, a second light source 308 can be used to provide a light 310 for producing the image for the sensor 302. The light 310 is reflected by the beam splitters 304 and 210 towards the subject 114, and then is reflected back towards the sensor 302. In some embodiments, the light 310 may have unique properties that do not interfere with the light 208. For example, the light 310 may not be visible light, or may be of a wavelength that is different from the light 208.

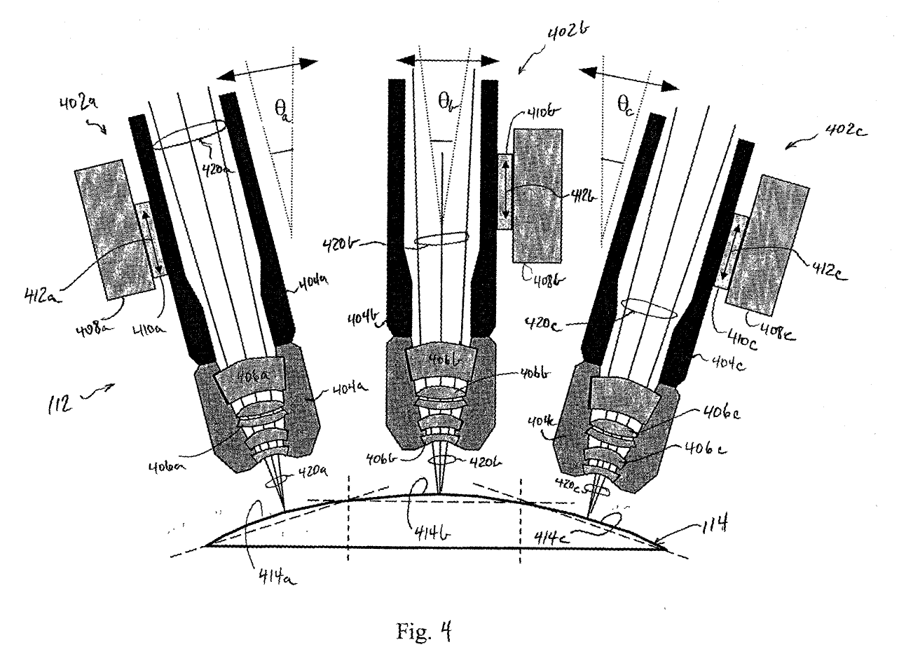

Referring now to FIG. 4, in other embodiments, the distortion compensation system 112 includes three different lens subsystems 402a, 402b, 402c, each of the lens subsystems being similarly constructed. For the sake of clarity, further reference will be made to individual subsystems by using suffixes “a,” “b,” and “c” corresponding to the subsystems 402a, 402b, 402c, respectively, and generically to the subsystems without using any suffixes.

Each subsystem 402 includes a housing 404 for securing and positioning one or more lenses 406. Each housing 404 further connects to a body portion 408 through a piezo-electric (PZT) device 410. Each PZT device 410 can move its corresponding body portion 408, relative to the subject 114, in a direction indicated by arrows 412. Although not shown, in some embodiments, additional PZT devices may be connected to each housing 404 for tilting the corresponding subsystems 402, as indicated by angles θ. Each subsystem 402 is directed towards, and responsible for exposing, a portion of the surface of the subject 114 identified as zones 412.

In one embodiment, three different mask images 420a, 420b, 420c are produced by three different portions of the mask(s) 108, 158. For example, three different analog masks (or three portions of a single mask) can produce the images 420. The subsystem 402a focuses the image 420a onto the surface zone 412a of the subject 114; the subsystem 402b focuses the image 420b onto the surface zone 412b; the subsystem 402c focuses the image 420c onto the surface zone 412c. Some embodiments may further utilize a scanning system for exposing the entire zone with the corresponding image, while other embodiments may use different technologies, such as step and scan. There are many embodiments of the distortion compensation system 112 that can incorporate one or more of the following functionalities.

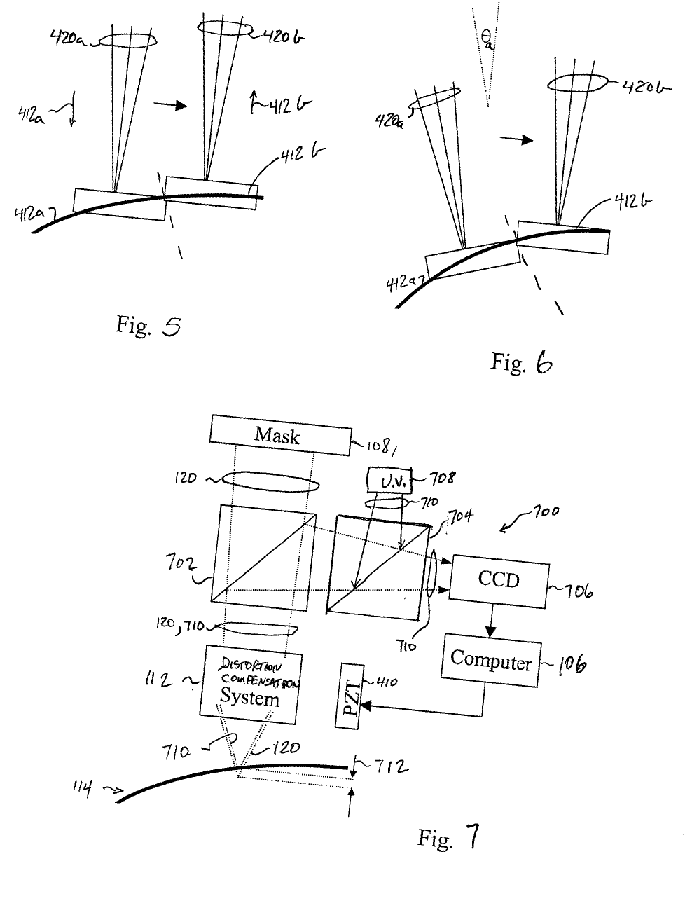

Referring also to FIG. 5, in some embodiments, each of the subsystems 402 are maintained in a parallel relationship to each other. To accommodate for non-planar variations in the surface of the subject 114, one or more of the PZTs 410 can move the distortion compensation system in a direction indicated by the arrows 412. As illustrated in the example of FIG. 5, the PZT 410a has moved the body portion 408a downward in the direction 412a, and the PZT 410b has moved the body portion 408b upward in the direction 412b.

Referring also to FIG. 6, in some embodiments, each of the subsystems 402 do not have to be maintained in a parallel relationship to each other. For example, the subsystem 412a may be moved in an angular manner, represented by the angle θA, away from a “normal” position (such as is illustrated in FIG. 5). It is understood that the term normal normally means perpendicular to the subject 114, but in the present example, the angle θA actually helps to align the subsystem 402a closer to a perpendicular relationship with the specific surface zone 412a. As illustrated in the example of FIG. 6, the surface zone 412a is angled to the left, and the subsystem 402a is tilted to the left to help compensate for this surface distortion.

In some embodiments, each of the different mask portions that correspond to the different mask images 420a, 420b, 420c are moved and/or rotated in accordance with the movement and rotation of the subsystems. Furthermore, additional light sources 102 and/or first lens systems 104 (if used) may also need to be moved and/or rotated accordingly.

In the present embodiment, the angular movement of the subsystems 412 is accomplished by the PZTs 410. It is understood that in some embodiments, there may be multiple PZTs for each subsystem, with some performing the parallel movement described in FIG. 5, and/or some doing the angular movement described in FIG. 6. Furthermore, it is understood that the drawings of the present patent are two dimensional, and that additional PZTs can be employed to provide additional movement to compensate for surface distortion.

Referring now to FIG. 7, with reference to the embodiments discussed above with respect to FIGS. 4-6, the movement of the subsystems 412 by the PZTs 410 can be accomplished by a distortion detection system 700. The distortion detection system 700 includes two beam splitters 702, 704, an imaging system 706 connected to a computer (such as the computer 106 of FIG. 1), and a secondary light source 708. It is understood that there are many possible combinations of devices that can perform distortion compensation, such as having a different numbers of beam splitters.

In the present embodiment, the secondary light source 708 produces an ultraviolet (UV) light 710 which does not adversely react with the photo resist 118 on the subject 114. The UV light 710 reflects off the beam splitters 704, 702 and towards the subject 114. The UV light 710 then reflects off of the subject 114, back through the beam splitters 702, 704, and onto the imaging system 706. The imaging system 706 provides corresponding data to the computer 106, which determines a depth of focus for the UV light 710. It is known that in the present embodiment, there is an offset 712 between the depth of focus for the UV light 710 and the depth of focus for the imaging light 120. With consideration of the offset 712, the computer 106 can control the PZTs 410 to properly move and/or orient the subsystems 412 (FIG. 5 and/or FIG. 6). As a result, the PZTs 410 (which are actually part of the distortion compensation system 112 in the present embodiment) can maintain a proper depth of focus in near real-time. It is further understood that by comparing the depth of focus for the different subsystems 412a, 412b, 412c, the computer can map the surface of the subject 114, and can predict future adjustments to the PZTs 410 to provide a real-time focus.

Referring to all of the FIGS. , with the embodiments discussed above, it is often known what the surface distortion will be. For example, in manufacturing spherical-shaped semiconductors, such as is disclosed in U.S. Pat. No. 5,955,776 (which is hereby incorporated by reference), it is known that the subject is spherical, and the surface distortion can be predetermined. In these embodiments, the position of the subsystems 412 (FIG. 4) and/or the phase shift device 202 can be relatively fixed.

In other embodiments, the surface distortion may be an unknown variant. For example, a printed circuit board or a wafer may be relatively flat, but with a wavy surface due to various process irregularities. Or, a spherical device may have a known amount of distortion, but the surface may still have some irregularities that need to be addressed. In these embodiments, the positions of the subsystems 412 and/or the phase shift device 202 can be variable, as discussed above.

While the invention has been particularly shown and described with reference to the preferred embodiment thereof, it will be understood by those skilled in the art that various changes in form and detail may be made therein without departing from the spirit and scope of the invention. Furthermore, the order of components may be altered in ways apparent to those skilled in the art. Additionally, the type and number of components may be supplemented, reduced or otherwise altered. Therefore, the claims should be interpreted in a broad manner, consistent with the present invention.

What is claimed is:

1. A distortion compensation system for use in an imaging device projecting an image with a plurality of portions onto a subject, the system comprising:
a plurality of light-distance modulators corresponding to the plurality of image portions;
a mechanical manipulator for individually manipulating each of the light-distance modulators;
whereby any distortion in the subject is compensated by the individual manipulation of the light-distance modulators.

2. The system of claim 1 further including:
a sensor for detecting an amount of the distortion in the subject and providing indication of the amount to the mechanical manipulator so that the light-distance modulators can be manipulated according to the amount.

3. The system of claim 2 wherein the imaging device is a scanning device and the mechanical manipulator is operable to manipulate the modulators while the imaging device is scanning.

4. The system of claim 2 further comprising:
a first light source for providing an imaging light and a second light source for use by the sensor.

5. The system of claim 4 further comprising:
an optical device for combining the first and second light sources and directing the combined light sources towards the subject.

6. An optical system for use with an image source for projecting an image onto a surface having a surface plane, the system comprising:
a first optical device corresponding to the surface plane and spaced from the surface plane at a predetermined distance, the first optical device including a plurality of individual distance modulators each for receiving a portion of the image and reflecting the image portion to a portion of the surface, each modulator individually adjustable to modify the distance between it and the surface plane; and
a second optical device for receiving the image and directing the image towards the first optical device.

7. The system of claim 6 further comprising:
a third optical device for sensing a distortion in the surface and providing information according to which the modulators of the first optical device should be adjusted.

8. The system of claim 6 further comprising:
a light source for projecting a light for display on the surface and reflection back to the third optical device, the light source being separate from the image source.

9. The system of claim of claim 6 wherein the third optical device is a Shack-Hartmann wavefront sensor and the second optical is a beam splitter.

10. A system for projecting an image onto a surface, the surface having first and second portions that are not planar with each other, the system comprising:
a first light source for projecting a first light;
a mask comprising first and second mask portions for converting the first light to first and second images, respectively;
first and second lens subsystems corresponding to the first and second images and the first and second surface portions, respectively; and
first and second support structures for individually positioning the first and second lens subsystems and mask portions, respectively, so that a depth of focus for the first and second images can be individually adjusted for the corresponding surface portion.

11. The system of claim 10 wherein the first support structure includes a micro-manipulator to provide variable adjustments to the orientation of the first lens subsystem.

12. The system of claim 11 wherein the micro-manipulator is a piezo-electric vibrator.

13. The system of claim 11 wherein the micro-manipulator moves the first lens subsystem in a direction that is perpendicular to a plane associated with the first surface portion.

14. The system of claim 11 wherein the micro-manipulator moves the first lens subsystem in a radial direction, compared to a line that is perpendicular to a plane associated with the first surface portion.

15. The system of claim 11 further comprising:
a sensor for detecting a position of the first surface portion for us in the adjustment of the micro-manipulator.

16. The system of claim 15 further comprising:
a scanning system for moving the subject relative to the mask; and
a computer for receiving an output from the sensor and controlling the micro-manipulator according to the output while the subject is being moved by the scanning system.

17. The system of claim 15 further comprising:
a second light for reflecting off the first and second portions of the surface and for use by the sensor; and
an optical device for combining the first and second lights.

19. The system of claim 17 wherein the second light is ultra-violet.

20. A digital photolithography system for projecting an image onto a surface having first and second portions, the system comprising:
a first light source for projecting a first light;
first and second digital pixel panels for converting the first light to first and second images, respectively;
first and second lens subsystems corresponding to the first and second images and the first and second surface portions, respectively; and
a first micro-manipulator for individually positioning the first lens subsystem so that a depth of focus for the first image can be individually adjusted for the corresponding surface portion.

21. The system of claim 20 further comprising:
a second micro-manipulator also for positioning the first lens subsystem;
wherein the first micro-manipulator is capable of moving the first lens subsystem in a first direction that is perpendicular to a plane associated with the first surface portion, and the second micro-manipulator moves the first lens subsystem in a second direction that extends radially from the first direction.

22. The system of claim 21 further comprising:
a second light source for producing a second light;
a beam splitter for combining the first and second lights;
a distortion detection system for receiving a reflection of the second light from the first portion of the surface and for controlling the movement of the first and second micro-manipulators accordingly.
